(19) United States
(12) Patent Application Publication
(10) Pub. No.: US 2008/0283513 A1
(43) Pub. Date: Nov. 20, 2008

(54) Heating Pad for Use with Animals

(75) Inventors: Ben T. Ferguson, III, Knoxville, TN (US); Marc E. Brush, Knoxville, TN (US); Terry G. Carpenter, Knoxville, TN (US); Nianhong Zhou, Tianhe District (CN)

Correspondence Address: PITTS AND BRITTIAN P C, P O BOX 51295, KNOXVILLE, TN, 37950-1295, US

(73) Assignee: Radio Systems Corporation, Knoxville, TN (US)

(21) Appl. No.: 11/749,146

(22) Filed: May 15, 2007

(51) Int. Cl. A01K 29/00; H05B 3/18

(52) U.S. Cl. 219/217

(57) ABSTRACT

A heating pad for use with animals, or pet heating pad. The pet heating pad provides a pad with a cushioned exterior and a flexible but resilient interior that prevents overheating by maintaining or returning the pet heating pad to a flat profile. The pet heating pad heating system includes a heating element with temperature limitation controls for safe operation surrounded by layers of material selected for temperature control properties. The result is a pet heating pad that substantially reduces or eliminates the problems normally associated with heating pads such as hotspots, overheating, bunching, and folding while providing a pet with a physically and thermally comfortable surface upon which to rest.

### CROSS-REFERENCE TO RELATED APPLICATIONS

Not Applicable

### STATEMENT REGARDING FEDERALLY-SPONSORED RESEARCH OR DEVELOPMENT

Not Applicable

### BACKGROUND OF THE INVENTION

1. Field of Invention

The present application relates to a heating pad for an animal. More specifically, the present application relates to a heating pad for use with an animal bed.

2. Description of the Related Art

Many house pets, especially dogs and cats, find a heated bed or blanket pleasing on which to lie. Thus, electric heating pads have been used for warming pet beds for some time. One problem that occurs when using a conventional heating pad is that a pet can fold or bunch-up the heating pad. Folding or bunching a heating pad increases the risk that the heating pad will overheat because the heating elements are then concentrated in a smaller area with more layers of insulation preventing the heat from escaping. While it is known to incorporate temperature limiting devices, such as a thermostat, into a heating pad in order to reduce the likelihood of overheating, such solutions are incomplete because of the uneven distribution of temperature within the heater elements, creating “hotspots.” Depending on the design and materials, heating pads which overheat are subject to failure resulting in damage to the components of the heating pad and risk of becoming a fire or electrical hazard.

The following patents and published applications are typical of the heating pads found in the prior art:

| U.S. Patent/Publication | Inventor(s) | Issue/Publication Date |
|---|---|---|
| 2006/0288949 | Axinte, et al. | Dec. 28, 2006 |
| 2006/0272582 | Dunn, et al. | Dec. 07, 2006 |
| 2006/0236946 | Behnke, et al. | Oct. 26, 2006 |
| 7,117,816 | Benhke, et al. | Oct. 10, 2006 |
| 6,237,531 | Peeples, et al. | May 29, 2001 |
| 6,189,487 | Owen, et al. | Feb. 20, 2001 |
| 6,084,209 | Reusche, et al. | Jul. 04, 2000 |
| 6,006,136 | Glucksman | Dec. 21, 1999 |
| 5,432,322 | Ingram, et al. | Jul. 11, 1995 |
| 4,149,066 | Niibe | Apr. 10, 1979 |

It is quite common for an animal to turn several times before lying down to shape the area. Generally, the prior art heating pads and heated pet beds are constructed using pliable materials which can be easily folded or bunched by an animal moving on or about the prior art heating pads thereby creating hotspots. Some of the prior art heating pads and heated pet beds use securing mechanisms to secure the edges in an attempt to prevent folding or bunching. An example of such is found in U.S. Pat. No. 6,237,531, issued to Peeples, et al. However, should the securing mechanism not be engaged or become disengaged, the heating pad or heated pet bed is then subject to folding or bunching and the resulting dangers of hotspots and overheating. U.S. Pat. No. 6,084,209, issued to Reusche, et al., describes a heated pet bed that prevents folding by forming a rigid outer casing having six sides in which the heating element is housed. However, the heated pet bed described by Reusche, et al., is not easily transportable and is less comfortable due to rigid housing.

### BRIEF SUMMARY OF THE INVENTION

A heating pad for use with animals, or pet heating pad, is summarized below without intending to limit the invention. The pet heating pad provides a pad with a cushioned exterior and a flexible but resilient interior that prevents overheating by maintaining or returning the pet heating pad to a flat profile. The pet heating pad heating system includes a heating element with temperature limitation controls for safe operation surrounded by layers of material selected for temperature control properties. The pet heating pad substantially reduces or eliminates the problems normally associated with heating pads such as hotspots, overheating, bunching, and folding while providing a pet with a physically and thermally comfortable surface upon which to rest.

Generally, the pet heating pad includes a heating element, one or more fixing layers, one or more cushioning/insulating layers, and one or more shaping layers, all arranged within a shell. Optionally, the pet heating pad also includes one or more thermal distribution layers. The function layers of the pet heating pad may be implemented in combination in a single physical layer or split into multiple layers to accommodate various design concerns.

At the core of the pet heating pad is a heating element. The heating element is heater wire restricting the flow of electricity and producing heat. The heater wire is arranged to fill a selected area of the pet heating pad with a selected separation between the parallel legs of the heating element and shaped to match the desired shape of the pet heating pad. The even distribution of the heater wire throughout the selected area provides an even temperature distribution. For safety, the heating element includes one or more thermostats, limiting the maximum temperature of the heating element, and fuses limiting the amount of current drawn through the heating element. The fixing layers have adhesive on the sides engaging the heating element. The adhesive secures the heating element to the fixing layer, which prevents the electrical components of the heating element, in particular the heating wire, from moving and bunching up and creating hotspots or an uneven temperature distribution. The thermal distribution layers are fabricated from a thermally-conductive material to further enhance the evenness of the temperature distribution by conducting but not storing heat when the thermally-conductive material is placed proximate to or in direct contact with the heating element. The cushioning layer is positioned above the heating element/fixing layer assembly such that the heating element does not make a pet resting on the pet heating pad uncomfortable, either physically and/or thermally. More specifically, the cushioning layer provides physical comfort for the pet by reducing or eliminating the perception of any hard or sharp components in the heating element and provides thermal comfort for the pet by sufficiently insulating the pet from the heating element to provide comfortable warmth over extended periods of time without the surface of the pet heating pad becoming uncomfortably warm. The pet heating pad also includes one or more resilient, semi-flexible support members that are substantially planar when at rest. The support members have sufficient rigidity to prevent folding or bunching of the pet heating pad while remaining sufficiently flexible to conform to the shape of the pet under normal usage by a pet or to be bent or rolled under intentional stress such as might be applied by the pet owner. By preventing the folding or bunching of the heating pad, the support member reduces or eliminates the risk of overheating or hot spots common to conventional heating pads. Further, the support members have sufficient elasticity or resilience to return to the substantially planar resting position when stress is removed. The shell defines the outer surface for the pet heating pad and encases the other layers. The shell is generally fabricated as a two-piece assembly with the two pieces being closed, joined, or sealed together.

### BRIEF DESCRIPTION OF THE SEVERAL VIEWS OF THE DRAWINGS

The above-mentioned features will become more clearly understood from the following description read together with the drawings in which:

FIG. 1 is an exploded view of one embodiment of the heating pad for use with animals showing the component layers;

FIG. 2 is a sectional view of one embodiment of the heating pad for use with animals;

FIG. 3 is a side elevation view of one embodiment of the heating pad for use with animals illustrating the resiliency of the heating pad; and

FIG. 4 illustrates one embodiment of the heating pad for use with animals as used with one type of conventional animal beds.

### DETAILED DESCRIPTION OF THE INVENTION

A heating pad for use with animals, or pet heating pad, is shown in the figures and described herein by the reference numeral 100. The pet heating pad provides a pad with a cushioned exterior and a flexible but resilient interior that prevents overheating by maintaining or returning the pet heating pad to a flat profile. The pet heating pad heating system includes a heating element with temperature limitation controls for safe operation surrounded by layers of material selected for temperature control properties. The result is a pet heating pad that substantially reduces or eliminates the problems normally associated with heating pads such as hotspots, overheating, bunching, and folding while providing a pet with a physically and thermally comfortable surface upon which to rest.

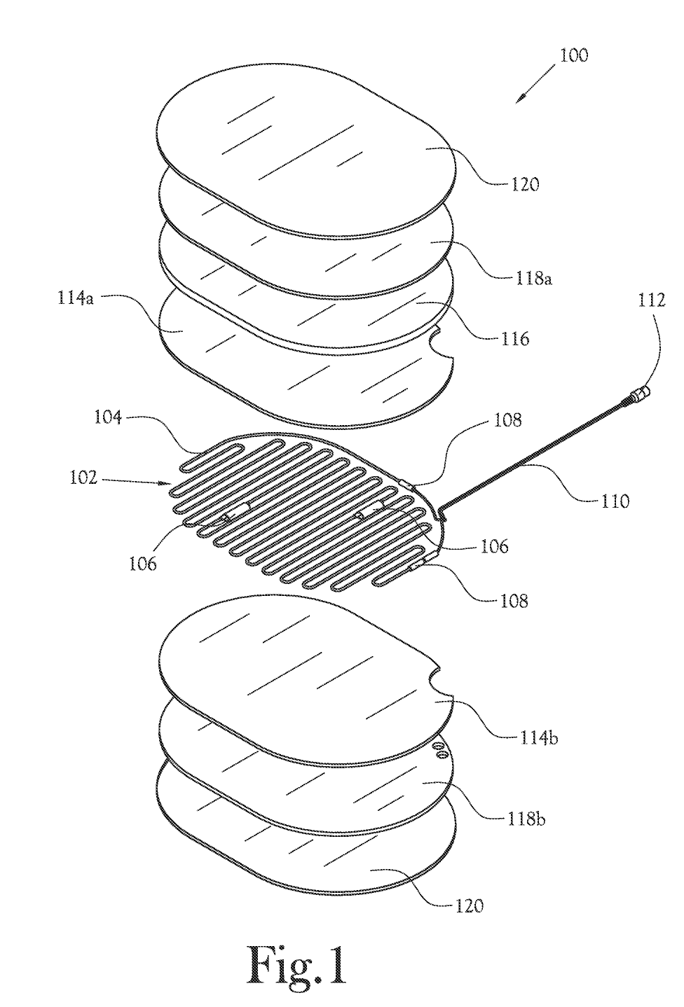

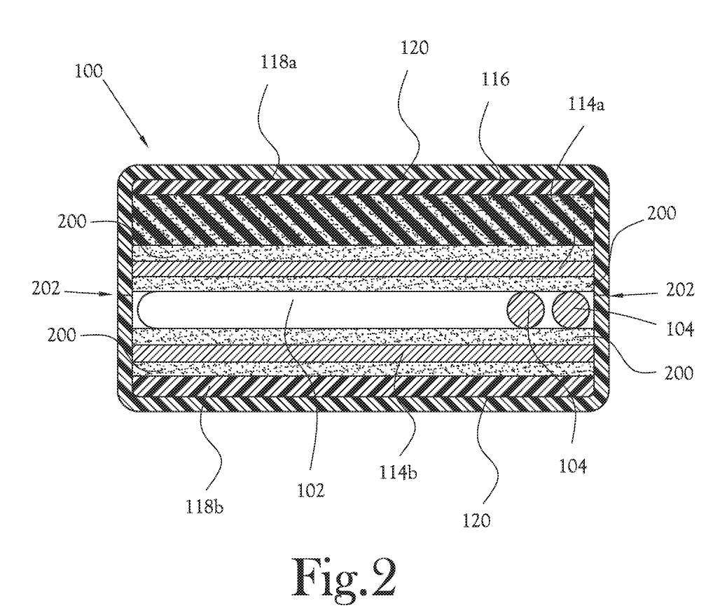

FIG. 1 illustrates an exploded view and FIG. 2 illustrates a sectional view of one embodiment of the pet heating pad 100 showing the component layers. Generally, the pet heating pad includes a heating element, one or more fixing layers, one or more thermal distribution layers, one or more cushioning/insulating layers, and one or more shaping layers, all arranged within a shell. At the core of the pet heating pad 100 is a heating element 102. The heating element 102 is heater wire 104 restricting the flow of electricity and producing heat. The heater wire 104 is arranged to fill a selected area of the pet heating pad 100 with a selected separation between the parallel legs of the heating element 102 and shaped to match the desired shape of the pet heating pad 100. The even distribution of the heater wire 104 throughout the selected area is intended to provide an even temperature distribution. In the illustrated embodiment, the heater wire 104 is arranged in a switchback pattern to form a substantially oval shape. One skilled in the art will recognize that the spacing, fill, and arrangement of the heater wire can vary without departing from the scope and spirit of the present invention

For safety, the heating element 102 includes one or more thermostats 106 and fuses 108 inline with the heating wire 104. The thermostats 106 limit the maximum temperature of the heating pad by interrupting current flow through the heating element 102 when a selected temperature is reached. The fuses 108 reduce or eliminate the risk of electrical shock by interrupting current flow through the heating element 102 if current in excess of the current rating of the fuse is drawn through the heating element 102. The heating element 102 is connected to a power cord 110. The power cord 110 delivers power to the heating element 102 from a power source (not shown). Typically, the power source is a transformer that rectifies and/or steps down an ac line voltage to a desired dc voltage suitable for driving the heating wire. In the illustrated embodiment, the heating element includes three heating wire segments connected by two thermostats to form a series heating circuit. Each end of the series heating circuit connects with one of end of the power cord and the fuse is placed inline between the at least one end of the power cord and one end of the series heating circuit. The illustrated power cord terminates with a connector 112 allowing removable attachment to a power source. One skilled in the art will recognize that the number of thermostats, fuses, and heater wire segments can vary without departing from the scope and spirit of the present invention.

On either side of the heating element 102 is a fixing layer 114a, 114b. At a minimum, the fixing layers 114a, 114b have a fixing mechanism such as an adhesive 200 on the sides engaging the heating element 102 and sealing the electrical components of the heating element 102 between the fixing layers 114a, 114b. The adhesive secures the heating element 102 to each of the fixing layers 114a, 114b preventing the electrical components of the heating element 102, in particular the heating wire 104, from moving and bunching up and creating hotspots or an uneven temperature distribution. In one embodiment, either the top fixing layer 114a or both fixing layers 114a, 114b are fabricated from a thermally-conductive material to further enhance the evenness of the temperature distribution, particularly when the thermally-conductive material is placed in direct contact with the heating element. Acceptable thermally-conductive materials include aluminum and other metal having good thermal conductivity. Generally, foils and films are used because the thin layer will distribute but not store much heat and will rapidly heat and cool. Providing the thermally-conductive material with a large surface area also provides rapid heating and cooling with minimal heat storage. In another embodiment, the adhesive layers are simply fabricated from any material suitable as carrier for an adhesive 200. Further, the fixing layer material(s) and the adhesive are selected for the ability to withstand the temperatures encountered due to proximity and/or engagement with the heating element 102. In the illustrated embodiment of FIG. 2, two fixing layers 114a, 114b are shown, each having adhesive 200 on both sides. One skilled in the art will recognize that either or both of the fixing layers may provide a fixing mechanism only on the heating element side without departing from the scope and spirit of the present invention. Although the fixing mechanism has been described herein as an adhesive, other fixing mechanisms including thermal or chemical bonds, physical restraints (e.g., staples, channels, clips, tape, etc.) may be substituted.

Next, a cushioning layer 116 is positioned above the heating element/fixing layers assembly such that the heating element 102 does not make a pet resting on the pet heating pad 100 uncomfortable physically and/or thermally. In one embodiment, the cushioning layer provides physical comfort for the pet by reducing or eliminating the perception of any hard or sharp components in the heating element 102. In another embodiment, the cushioning layer provides thermal comfort for the pet by sufficiently insulating the pet from the heating element to provide comfortable warmth over extended periods of time without the surface of the pet heating pad becoming uncomfortably warm. Materials suitable for accomplishing both purposes include a selected thickness of foam or cotton batting/wadding. One skilled in the art will recognize other materials suitable for meeting one or both of these comfort concerns.

The pet heating pad 100 also includes one or more resilient, semi-flexible support members 118a, 118b that are substantially planar when at rest. The support members 118a, 118b have sufficient rigidity to prevent folding or bunching of the pet heating pad while remaining sufficiently flexible to conform to the shape of the pet under normal usage by a pet or to be bent or rolled under intentional stress such as might be applied by the pet owner. By preventing the folding or bunching of the heating pad, the support member reduces or eliminates the risk of overheating or hot spots common to conventional heating pads. Further, the support members have sufficient elasticity or resilience to return to the substantially planar resting position when stress is removed. At a minimum, the support members resist bunching as a result of an applied lateral force. Less flexible support members resist folding or rolling of the pet heating pad 100 and require a greater and/or intentionally applied force to overcome the initial resistance to bending, torsion, or rolling. The mechanical properties and fabrication materials of each shaping layer 118a, 118b are individually selectable. In one embodiment having more than one shaping layer, the desired mechanical properties for the shaping layers to resist or prevent bending, rolling, torsion, or folding are specified by a set of overall mechanical response characteristics of the pet heating pad 100 and the shaping layers are selected such that, in combination, the overall mechanical response characteristics are met or exceeded. In such a case, none of the individual shaping layers would necessarily meet the desired overall mechanical response characteristics individually. However, the ability to rely on the combination of shaping layers permits the use of individual shaping layers that are more flexible, form-fitting, or comfortable to the pet. In one embodiment, the support members are fabricated from a polymeric or plastic material such as rigid vinyl or polyester.

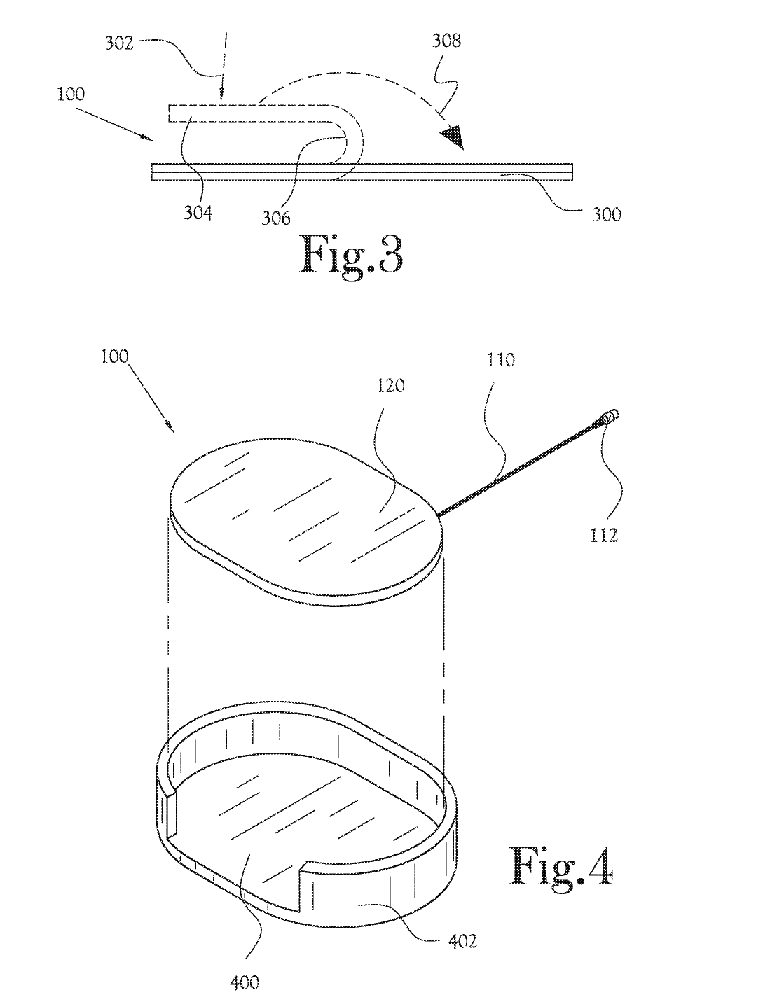

FIG. 3 illustrates the characteristics and operation of the pet heating pad 100 at rest and under an applied force. As previously mentioned, the pet heating pad 100, illustrated here in object lines, lies in a substantially flat position 300 when a rest. When a sufficient force 302 is applied to overcome the initially resistance to bending or torsion, the pet heating pad is moved into a bent position 304, illustrated in phantom lines. In the bent position 304, the flexibility characteristics operate to limit the minimum bend radius 306 to a radius that prevents damage to the heating element and prevents the pet heating pad from being bunched or actually folded absent damage to the support members. It is desirable but not required that the material selected for the shaping layers not easily be fractured or suffer other lasting effects from rolling or bending. When the applied force 302 is removed, the elastic force 308 of the shaping layers returns the pet heating pad to the substantially flat resting position 300.

Returning to FIGS. 1 and 2, a shell 120 encases the other layers and defines the outer surface for the pet heating pad. The shell 120 holds the components of the pet heating pad 100 together. The shell 120 is generally fabricated as a two-piece assembly with the two pieces being closed, joined, or sealed together thereby creating a seam 202. The method of closure depends largely on material selection and suitable methods of closure include the use of sewing, zippers, adhesives, chemical bonding, thermal bonding, sonic welds, and similar techniques and/or combinations of these techniques. The material used to fabricate the shell 120 is generally a durable, soft, and compliant material, such as poly-vinyl chloride or a fabric material. The heat expressed at the shell 120 is also a factor in material selection, although lack of direct contact with the heating element 102 and the insulation provided by the other layers of the pet heating pad 100 reduce the temperature extremes to which the shell 120 must endure. In addition, other characteristics relevant to the material selection for the shell 120 include appearance, texture, breathability, and care requirements. In one embodiment, the shell 120 is liquid impermeable to reduce or prevent the risk of electrical shock should the pet heating pad 100 be exposed to a liquid from a spill or the pet or other animal relieving itself on the pet heating pad 100.

It should be noted that the embodiment illustrated in FIG. 2 shows the cushioning layer 116 and the top fixing layer 114a being attached with a layer of adhesive 200. Similarly, the bottom fixing layer 114 is shown as attached to the lower support member 118b. One skilled in the art will recognize that such adhesive is not required as these components are encased within the shell. In some conditions, there are potential advantages, such as reducing stress on the heating element, by allowing the fixing layers 114a, 114b to move relative to such an outer layer.

The number and arrangement of layers within the pet heating pad 100 may vary without departing from the scope and spirit of the present invention. Further, the functions of two or more layers may be combined or the functions provided by a single layer may be distributed between two or more layers without departing from the scope and spirit of the present invention. By way of example, one alternate embodiment of the pet heating pad uses a single layer to provide the functionality of both the shaping layer and the fixing layer by adhering the heating element to a flexible, substantially rigid, and resilient layer. In another embodiment, the functions of the cushioning layer are accomplished using two different layers—one for thermal insulation and another for making the pet heating pad a soft resting place. In another embodiment, a cushioning layer is placed on both sides of the heating element. In another embodiment, the shaping layer is located between the cushioning layer and the heating element. In another embodiment, no layer having thermal conduction properties is used. These alternate embodiments are not intended to be exhaustive or otherwise limit the scope of the pet heating pad described herein.

FIG. 4 illustrates the pet heating pad 100 used with a conventional pet bed 400. In the illustrated embodiment, the oval shape of the pet heating pad 100 matches the oval shape commonly found in a conventional pet bed 400 and most closely resembles the shape of a pet curled up to sleep or for warmth. When positioned, the pet heating pad 100 rests within and is held in place by the curved wall 402 of the conventional pet bed 400. One skilled in the art will recognize that the pet heating pad 100 may be fabricated in other shapes to match the shapes of other pet beds without departing from the scope and spirit of the present invention.

For use with pet beds that do not have walls, the pet heating pad may include a securing mechanism that allows the pet heating pad to remain attached to and properly positioned in relation to the pet bed. One suitable attachment mechanism is one or more straps or tie-downs which are releasably secured around the pet bed using knots, snaps, clasps, buttons, buckles, binders, hooks-and-loops, and/or other similar mechanisms. In one embodiment, the straps or ties surround both the pet heating pad and the pet bed and loops or through openings are optionally used to guide or position the straps. In another embodiment, the straps or ties pass through loops or through-openings in the pet heating pad, which serve as tether points and are optionally reinforced, and, thus, only surround the pet bed. In another embodiment, both the pet heating pad and the pet bed have loops or through-openings that provide cooperating attachment points where the pet heating pad and the pet bed are secured together. Another suitable attachment mechanism uses a gripping fastener to secure the pet heating pad to the pet bed. Such fasteners include a hook-and-loop fastener, a clip, or a clamp releasably mating the pet heating pad to the pet bed. More permanent attachment mechanisms involve sewing, riveting, or adhering the pet heating pad and the pet bed together. Another suitable attachment mechanism provides a pocket or compartment, which may optionally be closed using zippers, snaps, buttons, etc., in either of the pet heating pad or the pet bed for receiving the other. Finally, one skilled in the art will recognize that the pet heating pad may be used without a pet bed or provided with sufficient cushioning to serve as a heated pet bed.

While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants general inventive concept.

Having thus described the aforementioned invention, what is claimed is:

1. A heating pad for use with an animal, said heating pad comprising:
a heating element comprising a heater wire converting an electric current into heat, said heating element being flexible;
a shaping layer in contact with and secured to said heating element, said shaping layer being semi-flexible and resilient, said shaping layer fixing an arrangement of said heating element, said shaping layer resting in a substantially planar position, said shaping layer flexing but not bunching or folding when subjected to an applied pressure;
a cushioning layer disposed on one side of said heating element; and
a shell encasing said heating element, said fixing layer, said cushioning layer, and said shaping layer, said shell maintaining the relative positions of said heating element, said fixing layer, said cushioning layer, and said shaping layer, and said shell defining an outer surface of said heating pad for use with an animal.

2. The pet heating pad of claim 1 wherein said shaping layer conforms to the shape of the animal lying on said pet heating pad.

3. The pet heating pad of claim 1 wherein said heating element is secured to said shaping layer by an adhesive.

4. The pet heating pad of claim 1 further comprising a thermal distribution layer disposed on one side of said heating element.

5. The pet heating pad of claim 1 further comprising a thermal distribution layer disposed on one side of and in physical contact with said heating element.

6. The pet heating pad of claim 5 wherein said thermal distribution layer is fabricated from a thermally conductive material.

7. The pet heating pad of claim 5 wherein said thermal distribution layer allows rapid heating and cooling without storing excess heat.

8. A heating pad for use with an animal, said heating pad comprising:
a heating element comprising a heater wire converting an electric current into heat, said heating element being flexible;
a fixing layer in contact with and secured to said heating element, said fixing layer being flexible, said fixing layer fixing an arrangement of said heating element;
a cushioning layer disposed on one side of said heating element;
a shaping layer disposed on one side of said heating element, said shaping layer being semi-flexible and resilient, said shaping layer resting in a substantially planar position, said shaping layer flexing but not bunching or folding when subjected to an applied pressure; and
a shell encasing said heating element, said fixing layer, said cushioning layer, and said shaping layer, said shell maintaining the relative positions of said heating element, said fixing layer, said cushioning layer, and said shaping layer, and said shell defining an outer surface of said heating pad for use with an animal.

9. The pet heating pad of claim 8 wherein said shaping layer conforms to the shape of the animal lying on said pet heating pad.

10. The pet heating pad of claim 8 wherein said heating element is secured to said fixing layer by an adhesive.

11. The pet heating pad of claim 8 further comprising a thermal distribution layer disposed on one side of said heating element.

12. The pet heating pad of claim 8 further comprising a thermal distribution layer disposed on one side of and in physical contact with said heating element.

13. The pet heating pad of claim 8 wherein said fixing layer is fabricated from a thermally conductive material.

14. The pet heating pad of claim 8 wherein said fixing layer allows rapid heating and cooling without storing excess heat.
